(19) United States
(12) Patent Application Publication
(10) Pub. No.: US 2026/0103095 A1
(43) Pub. Date: Apr. 16, 2026

(54) MULTI-FUNCTIONALITY CHARGING STATION WITH MULTI-MODE MULTI-PURPOSE OPERATION AND CONTROL

(71) Applicant: THE BOARD OF TRUSTEES OF THE UNIVERSITY OF ALABAMA, Tuscaloosa, AL (US)

(72) Inventor: Jaber A. ABU QAHOUQ, Tuscaloosa, AL (US)

(21) Appl. No.: 19/113,769

(22) PCT Filed: Oct. 5, 2023
(86) PCT No.: PCT/US2023/034574

§ 371 Date: Mar. 20, 2025

Related U.S. Application Data
(60) Provisional application No. 63/378,674, filed on Oct. 6, 2022.

(51) Int. Cl. B60L 53/10; B60L 53/51; B60L 53/52; B60L 53/53; B60L 53/54; B60L 53/62; B60L 53/64; B60L 55/00

(52) U.S. Cl. CPC B60L 53/11; B60L 53/51; B60L 53/52; B60L 53/53; B60L 53/54; B60L 53/62; B60L 53/64; B60L 55/00; B60L 2210/10; B60L 2210/30

(57) ABSTRACT

Methods for providing power/energy to the charging station and/or using the charging stations to provide power/energy to other loads other than EVs/vehicles. Sources and loads may be connected to or tapped to a DC charging station using intermediate DC terminals between an AC-DC stage and a DC-DC stage. This will increase the utilization of EV DC charging stations, support their operation during peak power demands, and when there is a power outage, and make them useful to power other equipment/loads such as those at construction sites, among others. Further, second-use batteries may be employed as a source where the charging and discharging of the second-use batteries is performed in accordance with a state-of-health of the individual modules within the second-use batteries.

### CROSS-REFERENCE TO RELATED APPLICATION

This application claims priority to U.S. Provisional Ser. No. 63/378,674, filed Oct. 6, 2022, entitled “MULTI-FUNCTIONALITY CHARGING STATION WITH MULTI-MODE MULTI-PURPOSE OPERATION AND CONTROL,” which is incorporated herein by reference in its entirety.

### BACKGROUND

Charging stations are becoming more ubiquitous as the demand for electric vehicles (EVs) increases. Typically, charging stations are connected to an energy source, such as a single-phase or three-phase AC power/energy source provided by the electric grid. The charging station converts the input AC voltage to an intermediate DC voltage using a rectifier or AC-DC converter. The intermediate DC voltage is provided to the DC-DC power converter(s) that adjust the intermediate DC voltage to an appropriate value to charge, e.g., a battery-powered vehicle that is attached to the charging station. The controller of the DC-DC converter communicates with the vehicle or its battery management system and perform charging algorithms or charging modes for a given current and voltage set points.

A problem that arises is that the charging stations rely on the electric grid as a source of power/energy and there are times when the electric grid is off-line due to weather, construction accidents, vehicles that collide with distribution network components, intentional shutdowns, etc. There are also conditions when the power grid is available but weak such that it cannot provide the required power level. Conventional approaches to providing a backup energy source for a charging station typically include generators or uninterruptable power supplies (UPS). These backup sources typically provide an input AC voltage at, e.g., the input terminals of the charging station to which the electric grid connects. This requires controller circuitry, such as a transfer switch, which senses the loss of AC voltage from the electric power grid and switches to the backup power source. When power is restored to the grid, the transfer switch senses the restoration of power and switches from the backup power source to the electric grid.

However, when the electric grid is operational and a backup energy/power source is needed as a supplement, the backup source needs to be synchronized in phase and amplitude with the electric grid. This adds further complexities to the controller circuitry. Still further, when the external backup energy source is a DC source, the external DC source must be converted to AC to connect to the AC input power terminals of the charger station. Then this power is rectified through an AC-DC converter of the charging station or an additional AC-DC converter. This increases complexity and cost, reduces efficiency, might not be practical, and would require additional hardware and electronics to condition its power.

Another concern is the growing number of batteries that are used in every electric vehicle (frequently referred to by Second-Use Batteries or Second-Life Batteries). Often these are lithium-ion batteries containing cobalt, nickel, manganese, lithium and other material or components that can contaminate soil and water supplies if not properly recycled. Typically, batteries no longer meet the demands of electric vehicles when their state of health is below 80%. At this point, the batteries are often replaced. However, these batteries still may be used in other less demanding environments, but often are not presenting challenges in the waste stream and for recycling of the hazardous materials contained in the batteries.

### SUMMARY

The present disclosure describes systems and methods for providing power/energy to the charging station and/or using the charging stations to provide power/energy to other loads other than electric vehicles/vehicles. This increases the utilization of EV chargers (charging stations), supports their operation during peak power demands and when there is a power outage and makes them useful to power other equipment/loads such as those at construction sites, among others. In addition, the present disclosure provides an environment in which batteries that are no longer usable in EVs may be reused to further extend their usefulness and to remove them from waste and recycling streams.

In accordance with an aspect of the present disclosure, a DC charging station is described that includes an AC-DC power conversion stage that converts an input AC source of power to DC power. A DC-DC power conversion stage adapts the DC power provided by the AC-DC power conversion stage to a connected load to be charged. One or more external sources and/or loads may be connected to the DC charging station at intermediate DC terminals between the AC-DC power conversion stage and DC-DC power conversion stage, and a power converter that controls the charging or discharging of the one or more external sources and/or loads in accordance with the type of the external sources and/or loads, the power demand and/or availability, grid power availability or strength, energy pricing, and/or a state-of-health of each of the one or more external sources and/or loads. A multi-mode controller may control the power converter to regulate power flow into, or out of, the one or more external sources and/or loads. The DC charging station of the present disclosure can have internal and external interfaces that includes power and control connections such that variety of sources and load types can be connected to and disconnected from the charging station. An interface DC-DC converter performs control algorithms based on the source and load types.

This summary is provided to introduce a selection of concepts in a simplified form that is further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative implementations, is better understood when read in conjunction with the appended drawings. To illustrate the implementations, there are shown in the drawings example constructions; however, the implementations are not limited to the specific methods and instrumentalities disclosed. In the drawings:

FIG. 1 illustrates an example DC charging station in accordance with aspects of the present disclosure;

FIG. 2 illustrates an example wherein one or more external sources and/or loads are battery modules or packs;

FIG. 3 illustrates an example of how the batteries are interfaced with a DC bus of the DC charging station of FIGS. 1 and 2;

FIGS. 4 and 5 illustrate aspects of how the charging and discharging of the batteries of FIG. 3 is controlled;

FIG. 6 illustrates shows a high-level diagram that illustrates an example Multi-functional Multi-Use Interoperable Charging (M2UIC) System in accordance with aspects of the present disclosure;

FIGS. 7-12 illustrate various example external sources and/or loads that may be connected or tapped to the DC charging station in accordance with aspects of the present disclosure; and

FIG. 13 illustrates another example implementation in which the DC-DC converter of the DC charging station is used to interface with an external source or load.

### DETAILED DESCRIPTION

The present disclosure describes methods and systems for providing power/energy to charging stations and/or using the charging stations to provide power/energy to other loads other than electric vehicles/vehicles. This, for example, increases the utilization of EV chargers, supports their operation during peak power demands and when there is a power outage and makes them useful to power other equipment/loads such as those at construction sites, among others.

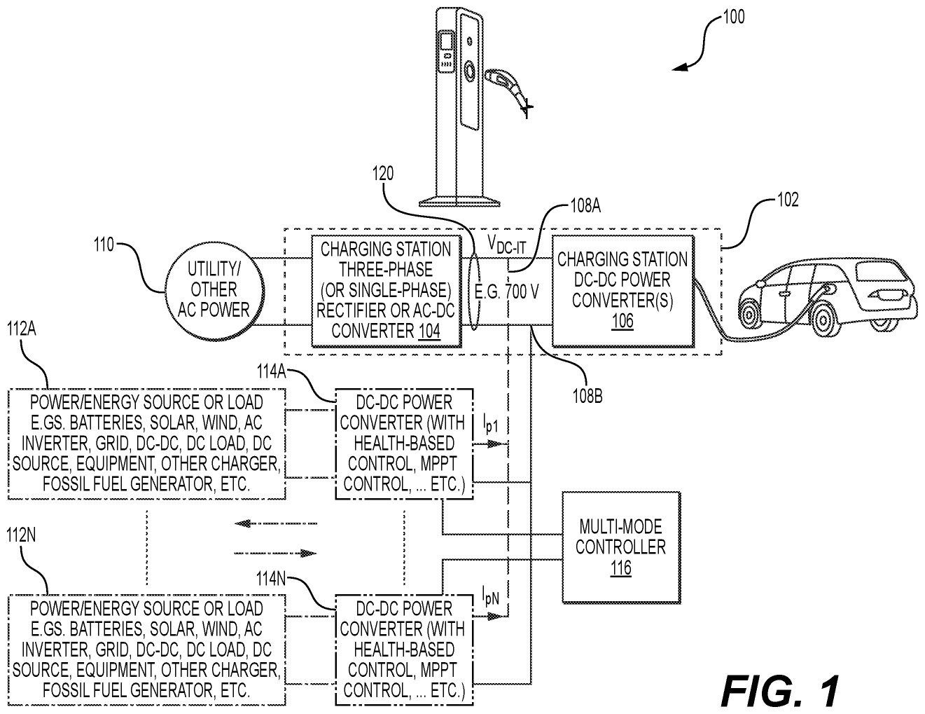

With reference to FIG. 1, there is illustrated an example environment 100 that includes a DC charging station 102 that further includes a rectifier or AC-DC power conversion stage 104 that converts an input AC grid power source 110 to DC and a DC-DC power conversion stage 106 that performs charging functions. In accordance with an aspect of the present disclosure, one or more external sources and/or loads 112A . . . 112N may be connected or tapped to the DC charging station 102 at intermediate DC terminals 108A and 108B between the AC-DC power conversion stage 104 and DC-DC power conversion stage 106 through power converter controllers (e.g., a DC-DC power converter) 114A . . . 114N (shown as V Bus 120). The one or more external sources and/or loads 112A . . . 112N may supplement the energy/power supply to the DC charging station 102 or receive energy/power supply from the DC charging station 102, as described below. When the one or more external sources and/or loads 112A . . . 112N provides energy/power to the DC charging station 102 the power converter controllers 114A . . . 114N clamp to a voltage (V_{DC-IT}) of the output AC-DC stage 104 (a VBus voltage of, e.g., 700V) and injects a current (e.g., Iₚ₁ . . . I_{pN}) into the DC charging station 102 at the intermediate DC terminals 108A and 108B.

By connecting the one or more external sources and/or loads 112A . . . 112N to the intermediate DC terminals 108A and 108B, the implementations of the present disclosure avoid the losses discussed above because there is no conversion from DC to AC and back to DC by the AC-DC power conversion stage 104. Further, there is no need to synchronize an AC input of the external source 112A . . . 112N with the AC grid power source 110 as the input at the intermediate DC terminals 108A and 108B is DC (i.e., 0 Hz).

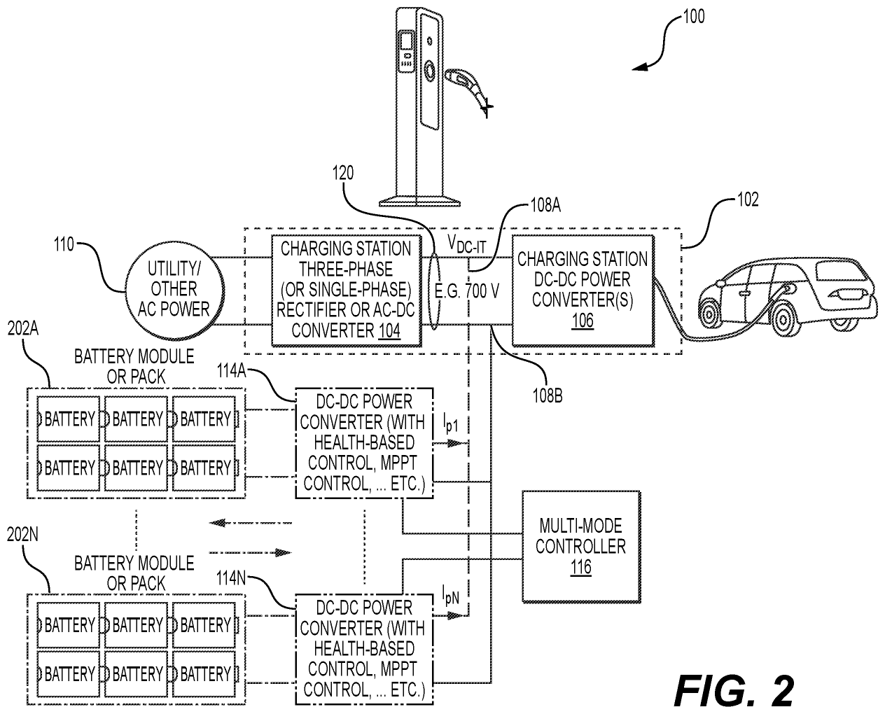

A multi-mode controller 116 operates to regulate the power flow into, or out of, the one or more external sources and/or loads 112A . . . 112N. As will be described below with reference to FIGS. 2 and 6-12, the one or more external sources and/or loads 112A . . . 112N may be numerous diverse types of sources of energy/power or loads that consume energy/power. For example, the one or more external sources and/or loads 112A . . . 112N may be batteries, solar cells, wind turbines, a DC micro-grid, another charger, a fossil fuel generator with a DC output, a hydrogen fuel cell with a DC output, tools and equipment, wireless chargers, wireless sources, etc.

The multi-mode controller 116 may be programmed to control the one or more external sources and/or loads 112A . . . 112N in numerous ways. Examples of the operational modes implemented by the multi-mode controller 116 may include, but are not limited to:
Using solar cells during daylight hours to supplement the power/energy supplied to the DC charging station 102 and other sources such as batteries during evening hours. For example, in this case the controller performs an algorithm to maximize the current injected into the bus in order to maximize the power/energy extracted from the solar cells or solar panels.
Charging batteries during periods of low demand or use of the DC charging station 102. For example, in this case the controller can perform contact current or constant voltage charging of the external battery. It can also control the charging power based on the state-of-health (SOH), temperature, electricity pricing, time of the day, and capacity, among others.
Charging batteries during periods when the AC grid power has a relatively lower cost.
Running a fossil fuel generator to provide power to the DC charging station 102 in accordance with environmental conditions, level of power demand, electricity and pricing/cost, among others.
Running the fossil fuel generator or hydrogen fuel cell when the AC grid power source 110 is offline.
Using any of the various available energy/power sources to provide supplemental power to tools and equipment in accordance with the utilization of the DC charging station 102.
Charging a source of energy/power while using another to provide supplemental power in accordance with cost and/or demand.
Charging and discharging batteries to maximize life in accordance with the state-of-health.

FIG. 2 illustrates a specific example where the one or more external sources and/or loads 112A . . . 112N are battery modules or packs (batteries) 202A . . . 202N. The batteries 202A . . . 202N may be new batteries or second-use batteries retired from electric vehicles, and they may be mounted on a mobile vehicle or a trailer proximate to the DC charging station 102. In the example of FIG. 2, the power converter controllers 114A . . . 114N may be bidirectional DC-DC power converters that provide part of, or all of, the charging power delivered by the DC charging station 102. In operation, the batteries 202A . . . 202N may be charged from the DC generator or the AC grid power source 110 through the AC-DC power stage converter 104 of the DC charging station 102 through the interface at the intermediate DC terminals 108A and 108B of the V Bus 120. For example, the batteries 202A . . . 202N can be charged from the AC grid power source 110 when there are no or little charging demands on the DC charging station 102 or when pricing is favorable for such charging. The batteries 202A . . . 202N can be used to provide charging power when charging demand is higher or if power provided to the DC charging station 102 is weak/not sufficient or not present. The DC generator operation point can be optimized for the best fuel conversion efficiency while using additional power from the battery. Especially if the battery is a second-use battery, the charge and discharge rates of the battery can be based on its health and to maintain its temperature within a safe range and optimum range for longer life. If there are several power converter controllers 114A . . . 114N for several batteries 202A . . . 202N, the converters can discharge or charge each battery at a rate that is optimized for its health, voltage range, state-of-charge, and temperature, among others.

Below are example, non-limiting, modes of operation of the multi-mode controller 116 in the system shown in FIG. 2:
Mode I—Charging second-use batteries from the power grid during off-peak power or low electricity pricing hours while an EV is being simultaneously charged: The controller (a) detects the status of off-peak power or low electricity pricing hours, (b) determines that one or more battery module(s) or pack(s) can be charged (at a speed appropriate to their capacity, SOC, and SOH, among others), and (c) confirms the FCS (Fast Charging Station) DC bus voltage is present (i.e., the power is available from the AC grid). If all of these conditions are satisfied, the controller activates the charging of the battery module(s) or pack(s) through their corresponding DC-DC converter(s) at a charging rate(s)/speed(s) that correspond to the State-Of-Health (SOH) value of each battery module or pack. This mode ends if (a) battery modules or packs are all charged, (b) the DC bus voltage of the FCS is lost (i.e., AC grid power outage or FCS failure/shutdown/blackout), or (c) a battery module or pack related issue is detected such as high temperature or sudden SOH degradation. During this mode since an EV is being charged by the FCS, the battery modules or packs charging rate/speed will be limited such that the FCS power capability is not exceeded (for example if the FCS has a maximum power capability of Y Watt and the EV is charging at X Watt rate, then the battery modules or packs maximum charging power is limited to Z=Y−X Watt).
Mode II—Discharging second-use batteries to cover part of the current/power needed to charge EVs during peak power or high electricity pricing hours: The controller (a) detects the status of peak power or high electricity pricing hours, (b) reads the amount of power needed for charging an EV, (c) determines that one or more battery modules or packs can be discharged, the amount of current/power that each battery module or pack can provide, and set the discharging current reference for each battery module or pack, and (d) confirms the FCS DC bus voltage is present (i.e., the power is available from the AC grid) in order for the DC-DC converter(s) to operate in current-mode control. If all of these conditions are satisfied, the controller activates the discharging of the battery modules or packs through their corresponding DC-DC converters at a charging rate(s)/speed(s) that correspond to the State-Of-Health (SOH) value of each battery module or pack. This mode ends if (a) battery modules or packs are all discharged, (b) the DC bus voltage of the FCS is lost (i.e., AC grid power outage or FCS failure/shutdown/blackout), or (c) a battery module or pack related issue is detected such as high temperature or sudden SOH degradation.
Mode III—Mode Il ends after all battery modules or packs reach the lowest allowed State-Of-Charge (SOC) while EV is still charging: This mode might occur only if the battery modules or packs reach their lowest allowed SOC before the EV finishes charging and now the FCS can continue to charge the EV using the power from the AC grid.
Mode IV—Charging second-use batteries from the power grid during off-peak or low electricity pricing hours while no EV is being simultaneously charged: This mode is the same as Mode I, except that there is no EV being charged by the FCS. The FCS is only charging the battery modules or packs at a rate appropriate for the SOH of each individual battery module or pack.
Mode V—The system operates as a backup power source when a power outage is detected or when FCS DC bus voltage is lost or low/weak: The controller detects a loss (or low value) of the DC bus voltage of the FCS and switches to voltage-mode control to create the DC voltage that the DC-DC stage of the FCS needs to continue charging the EV with limited charging power/current that the battery modules or packs are able to supply based on their SOC values and SOH values.

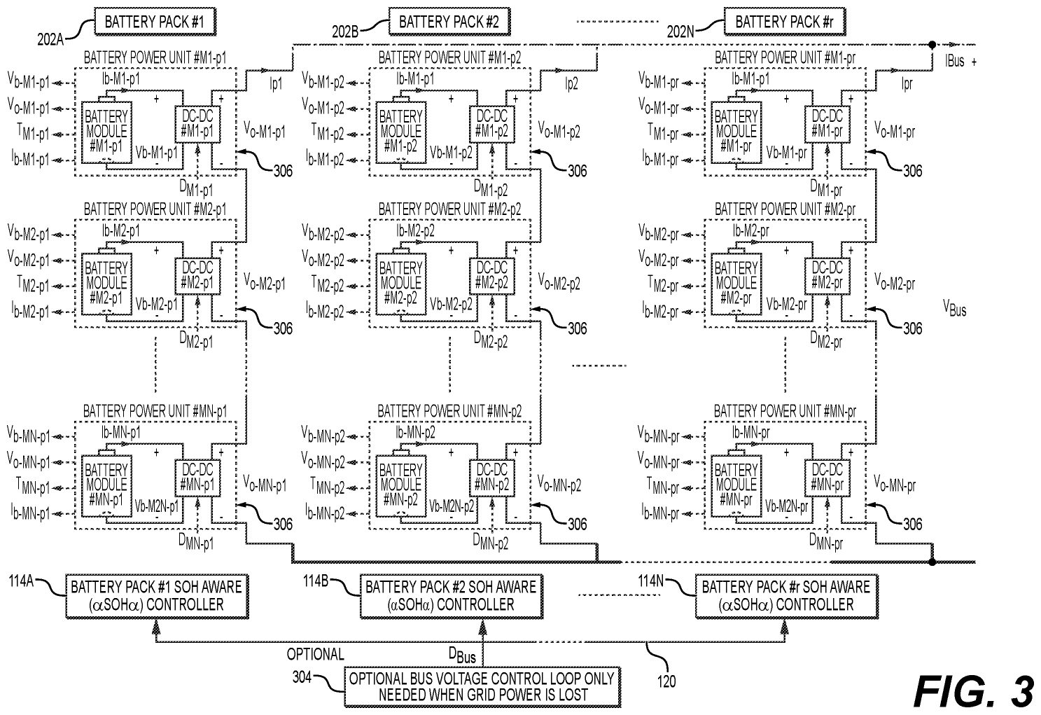

FIG. 3 illustrates an example of how the batteries 202A, 202B . . . 202N are interfaced with the VBus 120 of the DC charging station 102 and incorporate state-of-health considerations. Optionally or additionally, the VBus 120 may be controlled by a DC bus controller 304. As noted above, the batteries 202A, 202B . . . 202N may be second-use batteries that were retired from electric vehicles. As will be described below, the power converter controllers 114A, 114B . . . 114N consist of multi-input power electronics which can manage the charge and discharge rates of each module 306 in each battery pack (or each battery pack overall) based on state-of-health and other parameters.

In a first operational scenario, when AC grid power is available and the power demand is low (with lower cost/utility company rate), the battery packs 202A, 202B . . . 202N will be recharged each at a rate commensurate with their state of health. During periods of peak/high power demand (with higher cost/utility company rate), the battery packs 202A, 202B . . . 202N through their power converter controllers 114A, 114B . . . 114N will act as constant current sources (current control under this scenario) to supply part of the needed charging power to reduce demand on the grid. The current supplied by each battery pack 202A, 202B . . . 202N will be based on the state-of-health of each battery pack 202A, 202B . . . 202N and its capacity. Each power converter's αSOHα controller for each battery pack 202A, 202B . . . 202N will periodically perform state-of-health evaluation/check (such as by performing a small step current perturbation to measure the change in impedance of each battery pack 202A, 202B . . . 202N to infer the change in state-of-health) and adjust the current reference value for the current to be supplied by each second-use battery pack 202A, 202B . . . 202N and by each battery module in each battery back 202A, 202B . . . 202N. This is in addition to the slowly updating health information that is provided by a Battery Management System (BMS) and charge/discharge coulomb counting.

The second operational scenario is when grid power is not available due to weather conditions or a disaster. In this case, the power converters'output voltages will be regulated (instead of current) but with peak current limiting to provide voltage inputs to the chargers to charge the electric vehicles. The peak current for each second-use battery will be limited based on the state-of-charge and capacity of the second-use battery packs (and their modules) in addition to the health status.

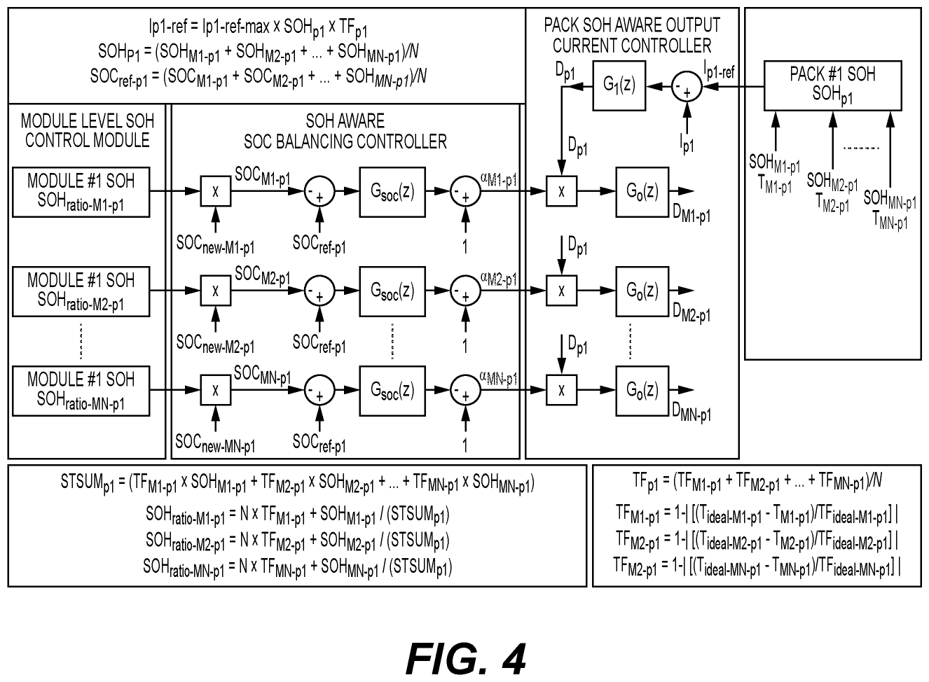

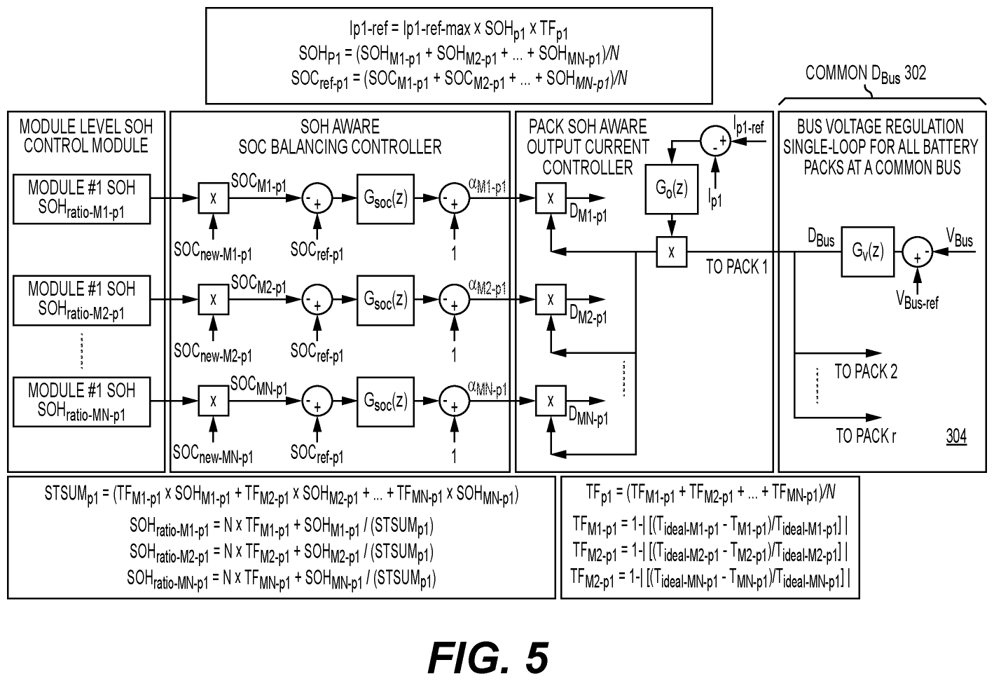

The state-of-health information may be obtained from the battery pack 202A, 202B . . . 202N or the module management system (BMS) unit of the manufacturer. In another example, the state of health information may be measured/estimated by the αSOHα controller using the systems and methods described with reference to FIGS. 4 and 5 that utilizes the DC-DC power converters'control for this purpose. The first option has the advantage of reduced system cost by reducing the need for the second option, but it also has an advantage of correlating and calibrating the results of the second option when it is used/available.

The electricity rate and demand information can be obtained by several means/options. One option is to utilize the published expected real-time pricing on an external website (e.g., EnergyDirect) where prices are quoted on an hourly basis for the next 24 hours. Forecasted and actual real-time pricing (RTP prices) are available on, e.g., EnergyDirect. For the day ahead (RTP DA), the prices are firm at 4:00 PM for the following day. For hours ahead (RTP HA), they get an update every hour when the price for the next hour is firm. Customers can set up alerts when the price exceeds their specified threshold. Other options to incorporate demand and pricing into the management of the battery include using Wi-Fi with vendor Application Programming Interface (API) to pull down pricing, using the Advanced Metering Infrastructure (AMI) network to receive a direct signal for the utility, and using a Distributed Energy Resource Management Systems (DERMS) to charge/discharge the BESS resource based on grid needs.

As also shown in FIG. 3, each battery pack 202A, 202B . . . 202N that is retired from an EV may include multiple battery modules 306. Even within the same battery pack 202A, 202B . . . 202N from the same EV, it is expected that the state-of-health (degradation level) for these battery modules 306 to be different, if not at the time of retirement from the EV then certainly as it is being used in the second-use application. Moreover, the voltage range and capacity values for the modules can be different based on the EV model for the same automotive manufacturer and from different automotive manufacturers (or their battery pack/system suppliers). Furthermore, the voltage required by the second-use application can vary and can be higher than the voltage of the battery module for different applications or even for different design scenarios for the same type of application.

Therefore, in accordance with aspects of the present disclosure, the batteries 202A, 202B . . . 202N may be managed at the module level when connected in series and/or in parallel to form a second-use battery system with the appropriate level of voltage and current outputs. As illustrated in FIG. 4, within each battery pack 202A, 202B . . . 202N (from a total of r battery packs) includes several modules 306, each has its own lower power DC-DC power converter rather than one higher power DC-DC power converter. The outputs of these module-level converters within each pack are connected in series. The number of these modules and their converters is scalable and depends on the desired total battery pack voltage (which is the bus voltage Vbus). One consideration for using several power converters is that when the state-of-health of the battery modules is below 70%-80% when they retire from electric vehicles, not only their state-of-health at that time will likely be different, but also the mismatch between their state-of-health is expected to increase as they age further during the second-use operation. This may mean that the power discharged (and charged) from each module 306 may be managed individually. These module-level power converters replace the need for passive and conventional module balancing electronics and control, which is not effective when the health of the modules is mismatched. Moreover, this allows, for example, for utilizing power devices that are with ≤˜600 V (down to 200 V) ratings if desired which are usually with lower cost for the same high current capabilities (cost reduction). Higher output voltage can be achieved by connecting these module-level converters in series. Since all the module-level converters carry the same pack current (Iₚᵣ) at their output, each of them can be discharged and charged at different rates (and therefore the battery modules can be discharged and charged at different rates) by mismatching their output voltages (in other words their switching duty cycles values).

The outputs of the battery packs 202A, 202B . . . 202N, each with its module-level converters, can be connected in parallel. As discussed earlier, each battery pack 202A, 202B . . . 202N, or more with module-level converters can be formed from the modules that exist in the original EV battery pack to reduce the repurposing cost and utilize part of the existing pack thermal management system.

The example control scheme that may be used for each battery pack 202A, 202B . . . 202N under the first operation scenario (when grid-power is available and therefore the bus voltage is available), as illustrated partially in FIG. 4, resides separately in each battery pack 202A, 202B . . . 202N with its module-level converters without the need to communicate information or control commands between the battery packs. Each battery pack 202A, 202B . . . 202N current is determined by the individual pack level state of health (SOHₚᵣ, where r =1, 2, . . . ) while the power drawn (discharge/charge rate) from each battery module within a battery pack is a function of the module-level state-of-health (SOHMN-Pr). The sample example equations shown in FIG. 4 show how the pack level SOHpr is derived from the module-level SOHMN-Pr and how these SOH values are used to modulate the current/power references at the module-level as well as at the pack level. The temperature is also used as a factor as shown in the equations in FIG. 4. These are non-limiting example equations provided for illustration. The source of the module-level SOH values (SOHMN-Pr) is discussed later/next.

FIG. 5 illustrates an example of the controller for the second scenario when the grid power is not available. Because under this condition the bus voltage is not created by the grid through the DC-AC inverter of the DC charging station 102, it needs to be created from the second-use batteries 202A, 202B . . . 202N. In this scenario, there is no VBus voltage output at by the AC-DC converter 104. Accordingly, the DC bus controller 304 may implement a voltage control loop (illustrated on the right-side portion of FIG. 5) which will generate a common duty-cycle DBus 302 to regulate the voltage at the desired value (e.g., 700 V) of the V Bus 120 of the DC charging station 102. This DBus value is sent to each pack power converter controller 114A, 114B . . . 114N. Except for this relatively simple external voltage regulation loop, each battery pack controller is separate and independent.

A unique feature of the αSOHα controller is its SOH control differential nature. The αSOHα determines and controls the charge/discharge rates based on the difference between SOH values and not only based on the absolute SOH values. This compensates for inaccuracies in SOH estimation and prevents undesired higher or lower discharge/charge rates. Moreover, the temperature of the modules is taken as a separate factor that determines the differential charge/discharge rates as partially illustrated in FIGS. 4 and 5.

The SOH algorithm of the αSOHα will perturb the reference current (in a step-function, ramp function, and sinusoidal-function format) in each module. This is to obtain a response for several variables. These variables may include, but are not limited to, the corresponding change in voltage (especially with respect to other modules), the DC resistance of each module, the complex impedance within a range of frequencies, the available capacity, and the temperature change. This information can be used by the SOH estimation algorithms to determine health scores. This provides a faster way to keep track of the SOH scores of different modules as they experience deep aging. The αSOHα will also keep track of the charged and discharged capacities to slowly measure the actual capacity of each battery module and calibrate the SOH estimation obtained by the perturbation scheme described above.

It is noted that the example configuration and control schemes of FIGS. 4 and 5 are provided herein for illustrative purposes. Other configurations and control schemes are contemplated by the present disclosure.

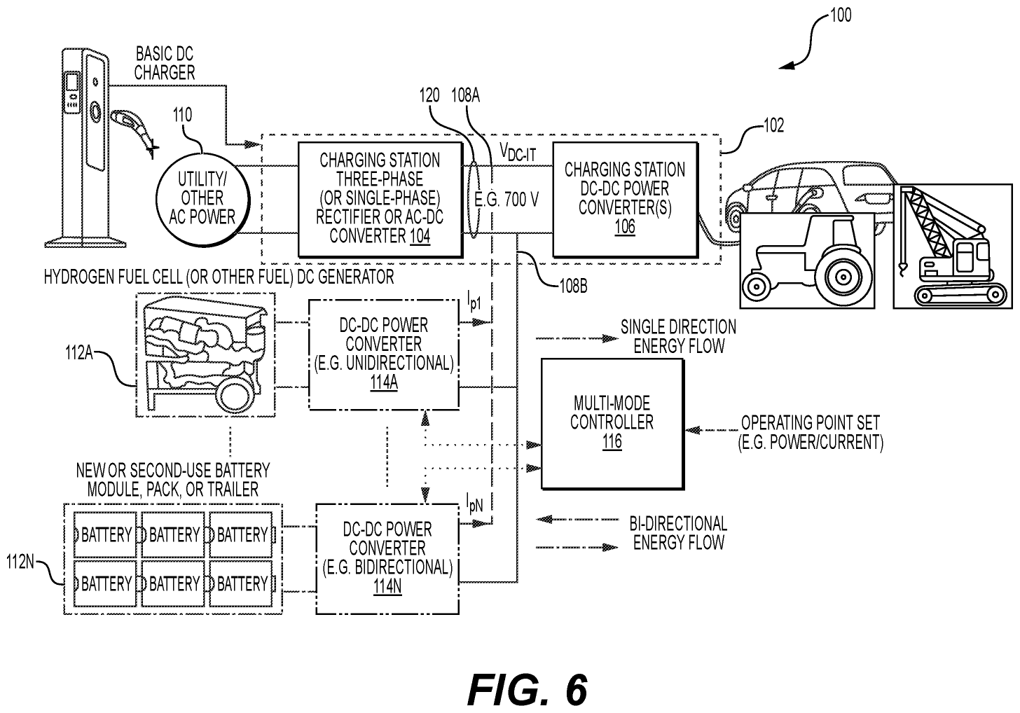

FIG. 6 shows a high-level diagram that illustrates an example Multi-functional Multi-Use Interoperable Charging (M2UIC) System. Each additional power/energy source (in addition to the original AC grid power source 110) is interfaced with the EV charging station/system through the controllable unidirectional or bidirectional DC-DC power converters 114A . . . 114N (depending on the source type) that has multiple functionalities and utilizes the output of the original AC-DC power conversion stage (the DC bus) of the EV DC charger without adding an AC-DC or DC-AC stage. Moreover, making the interface at the charger's DC bus rather than at the output of the charger makes use of the already standard charging functionality of the charger without interfering with its operation. To supplement the AC grid power or to substitute for it if it is missing, for examples in agricultural or construction sites where non-road EV charging is used/needed (in addition to chargers for road vehicles), one or more hydrogen fuel cell DC electric power generator is interfaced with the DC bus of the charger using a unidirectional DC-DC power converter with current-mode control (the voltage will be set by the charger's DC bus voltage). The DC generator may also be a generator that uses fuel other than hydrogen when needed as long as its output voltage range meets the interface DC-DC power converter input range/specifications. The DC bus can also be utilized for additional outputs to power other equipment. Yet further, one of the external sources and/or loads 112A . . . 112N may be a source and the other may be a load.

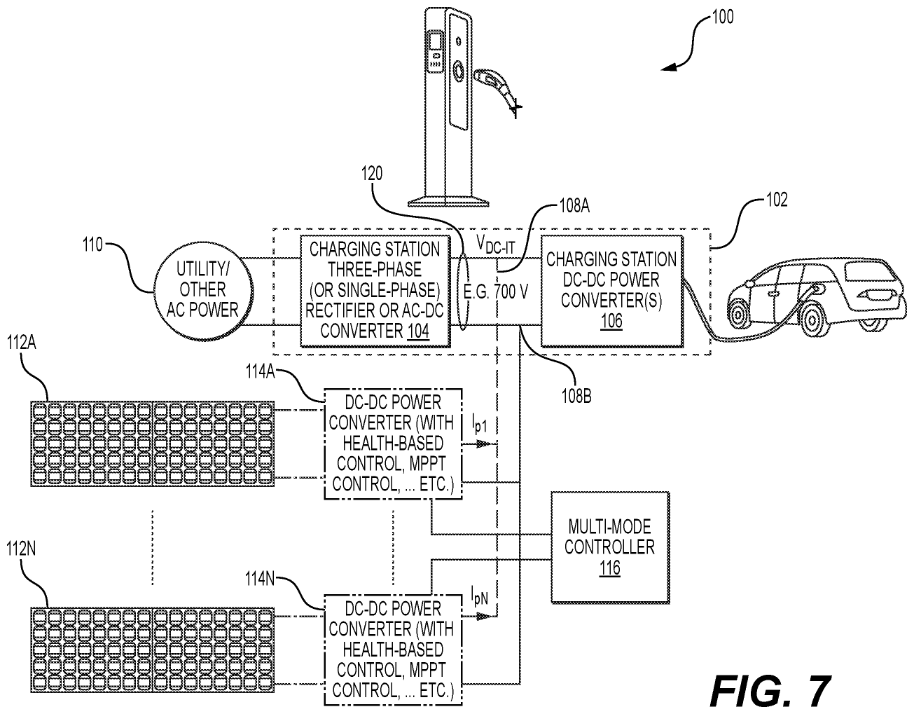

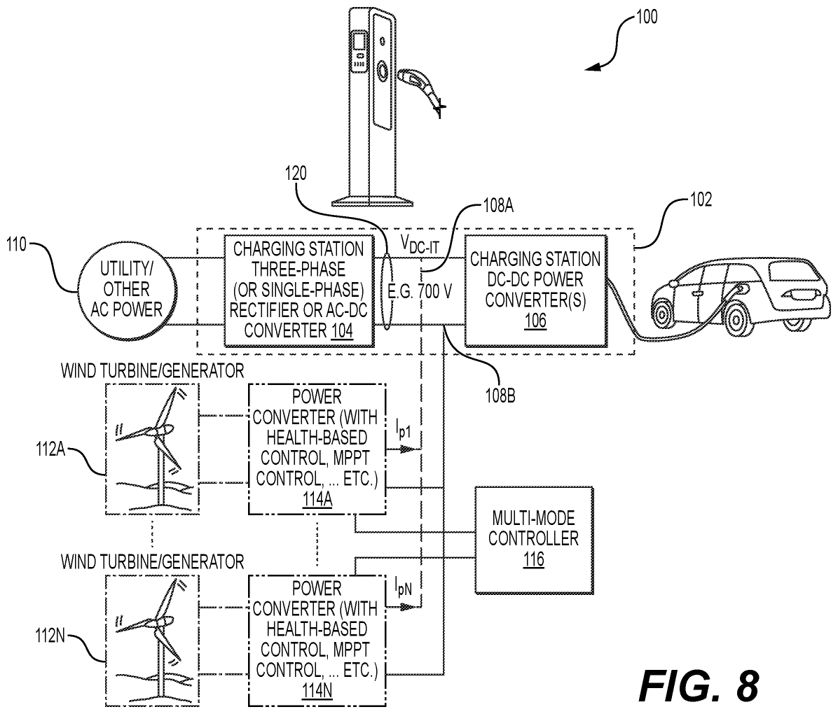

FIGS. 7-12 illustrate various example external sources and/or loads 112A . . . 112N that may be connected or tapped to the DC charging station 102 at the intermediate DC terminals 108A and 108B. As shown in FIG. 7, PV solar panels may be connected to the intermediate DC terminals in the EV DC charger through a DC-DC power converter that is used to scale the voltage/current and/or perform Maximum Power Point Tracking (MPPT) while matching the voltage (V_{DC-IT}) of the EV DC charger. When the AC grid power at the input of the charger is present, PV solar energy is used to provide part of the power to charge the EV. When the AC grid power at the input of the charger is not present (power outage for example during severe weather conditions, disasters, or in remote work areas), the PV solar energy is used to provide some power to charge the EV. FIG. 8 shows wind turbines can also be a source of energy.

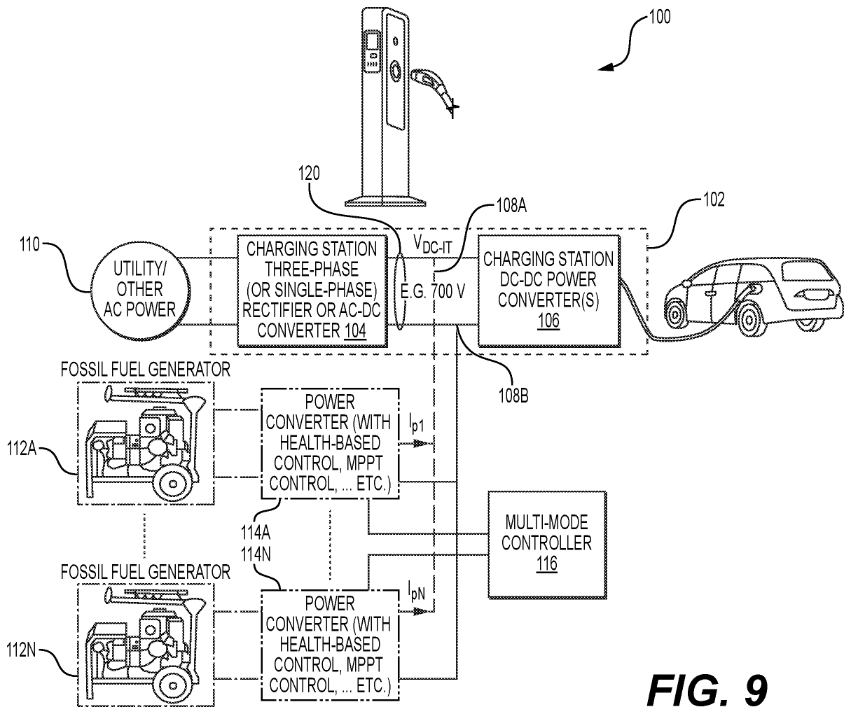

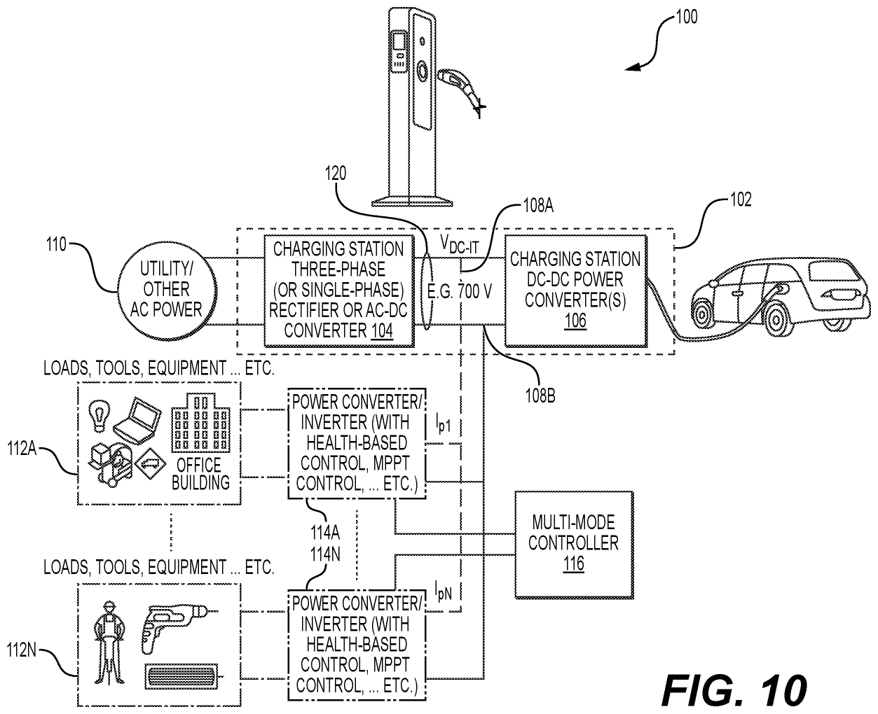

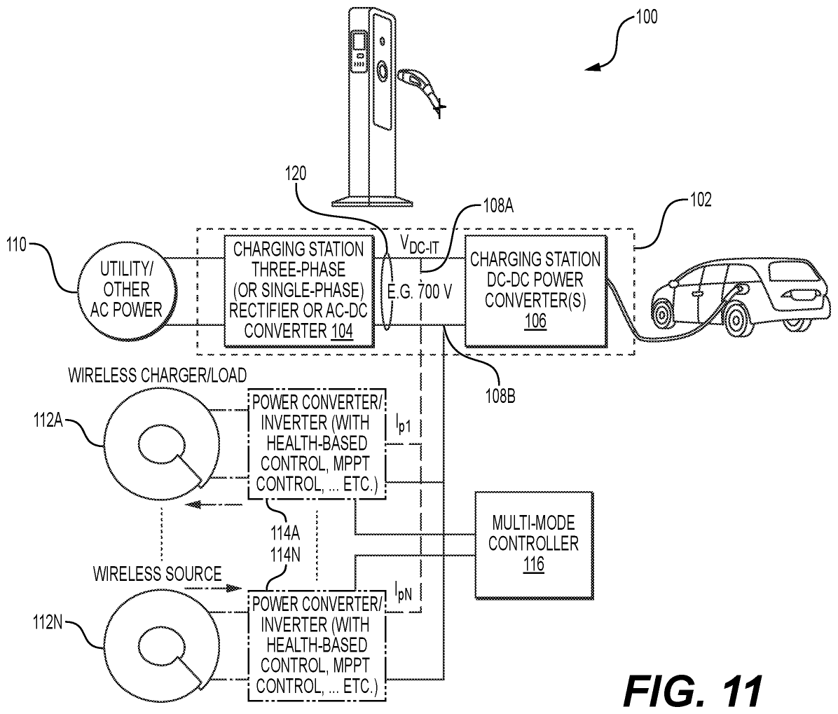

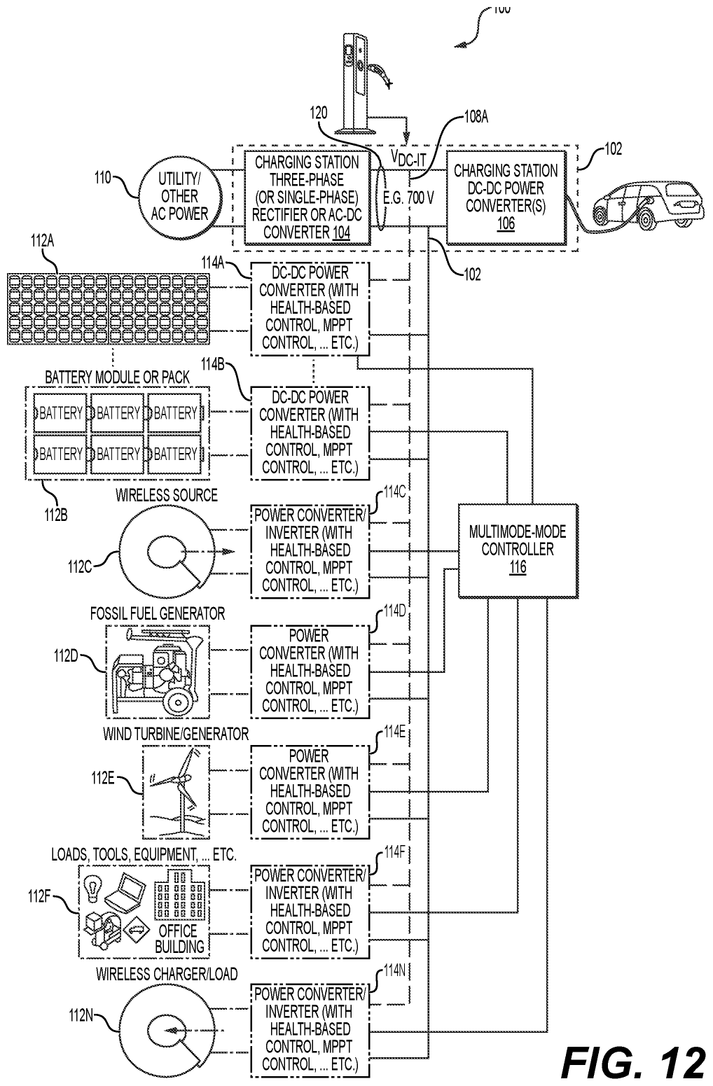

FIG. 9 illustrates example fossil fuel generators that may be used during power outages to supply power to the EV DC charger without having to go through the AC grid input. FIG. 10 illustrates a variety of loads such as those at construction sites or nearby businesses. FIG. 11 illustrates that the DC charger may provide additional wireless power charging terminals and/or wireless power sources for the charger. In this case, the EV DC charger itself can be used as a source for a wireless charger and it also can serve as a wireless receiver to provide power to the DC charging station 102 itself (for example during a power outage or to add power for example when the power level from the grid or other sources is not sufficient or weak). FIG. 12 illustrates that any combination of sources and loads may be connected to the DC charging station 102 at terminals 108A and 108B of the V Bus 120. While not all possible variations are shown in FIG. 12, one of ordinary skill in the art would understand that the implementations of the present disclosure will increase the utilization of the DC charging station 102. For example, when the DC charging station 102 is not charging electric vehicles, it may be used to charge other tools and equipment (112F).

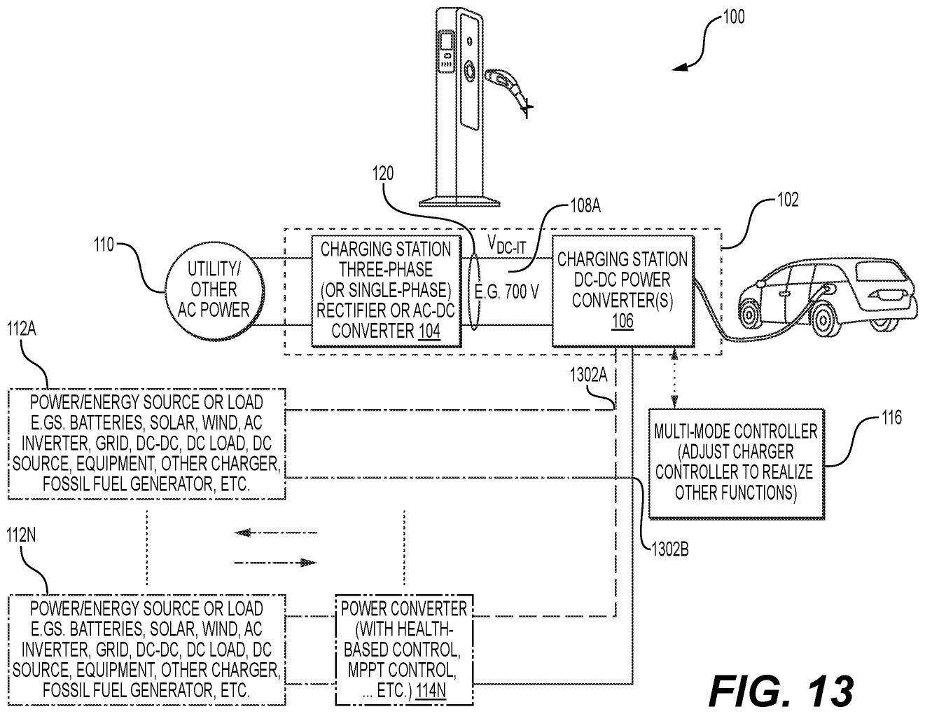

FIG. 13 illustrates another example implementation in which the DC-DC converter 106 of the DC charging station 102 is used to interface with an external source or load such that there is no need to add another power converter. In this case, the DC-DC of the power converter control mode will be based on the external source or load.

It should be noted that any of the executable instructions can be embodied in any computer-readable medium for use by or in connection with an instruction execution system, apparatus, or devices, such as a computer-based system, processor-containing system, or other systems that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example, but is not limited to, an electronic, magnetic, optical, electromagnetic, infrared, or semiconductor system, apparatus, or device. More specific examples (a non-exhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of implementations of this disclosure can include embodying the functionality described in logic embodied in hardware or software-configured media.

It should be emphasized that the above-described implementations are merely possible examples of implementations set forth for a clear understanding of the principles of this disclosure. Many variations and modifications may be made to the above-described implementations without departing substantially from the spirit and principles of the disclosure. All such modifications and variations are intended to be included herein within the scope of this disclosure.

1. A DC charging station, comprising,
an AC-DC power conversion stage that converts an input AC source of power to DC power;
a DC-DC power conversion stage adapts the DC power provided by the AC-DC power conversion stage to a connected load to be charged;
one or more external sources and/or loads that are connected to the DC charging station at intermediate DC terminals between the AC-DC power conversion stage and DC-DC power conversion stage;
a power converter that controls the charging or discharging of the one or more external sources and/or loads in accordance with a state-of-health of each of the one or more external sources and/or loads; and
a multi-mode controller that controls the power converter to regulate power flow into, or out of, the one or more external sources and/or loads.

2. The DC charging station of claim 1, wherein the one or more external sources and/or loads comprise batteries.

3. The DC charging station of claim 2, wherein the power converter is bi-directional,
wherein the batteries are charged from an AC power source under first conditions, and
wherein the batteries provide charging power to the DC charging station under second conditions.

4. The DC charging station of claim 3, wherein the first conditions exist when there are no or relatively small charging demands on the DC charging station, and wherein the second conditions exist when there are relatively high charging demands on the DC charging station.

5. The DC charging station of claim 3, wherein the power converter periodically checks the state-of-health of each module within each of the batteries to adjust a current supplied to each module within each of the batteries when charging, and
wherein the power converter periodically checks the state-of-health of each module within each of the batteries to adjust a current supplied by each module within each of the batteries when discharging.

6. The DC charging station of claim 5, wherein each module includes a module DC-DC power converter, and
wherein a state-of-health of each module is determined by the module DC-DC power converter, and
wherein the module DC-DC power converter is operable to charge and discharge its respective module in accordance with the module's state-of-health.

7. The DC charging station of claim 6, wherein each module's DC-DC power converter is connected in series to set a desired output voltage of each of the batteries.

8. The DC charging station of claim 6, further comprising a DC bus controller,
wherein when the first conditions comprise a loss of the input AC source of power, the DC bus controller implements a voltage control loop that regulates a bus voltage to a predetermined value associated with an operating voltage at the intermediate DC terminals.

9. The DC charging station of claim 2, wherein the batteries are second-use batteries having a capacity of less than or equal to 80%.

10. The DC charging station of claim 1, wherein at least one of the one or more external sources and/or loads is a source of DC power and wherein at least one of the one or more external sources and/or loads is a load at a same time.

11. The DC charging station of claim 1, wherein the multi-mode controller individually controls each of the connected external loads and external sources.

12. (canceled)

13. (canceled)

14. The DC charging station of claim 11, wherein the multi-mode controller utilizes the state-of-health of each of the one or more external sources and/or loads.

15. (canceled)

16. The DC charging station of claim 11, wherein multiple type of energy sources and loads are connected to the charging station through a DC bus and wherein the multi-mode controller adjusts energy or power flow directions and magnitude values between them and with the DC charging station based on multiple parameters including at least one of efficiency, health, temperature, pricing/cost, and demand.

17. (canceled)

18. A method, comprising,
converting an input AC source of power to DC power using an AC-DC power conversion stage in a DC charging station;
adapting, using a DC-DC power conversion stage, the DC power provided by the AC-DC power conversion stage to a connected load to be charged;
connecting one or more external sources and/or loads to the DC charging station at intermediate DC terminals between the AC-DC power conversion stage and DC-DC power conversion stage;
controlling, using a power converter, the charging or discharging of the one or more external sources and/or loads in accordance with a state-of-health of each of the one or more external sources and/or loads; and
controlling, using a multi-mode controller, the power converter to regulate power flow into, or out of, the one or more external sources and/or loads.

19. The method of claim 18, wherein the one or more external sources and/or loads comprise batteries.

20. The method claim 19, further comprising:
providing the power converter is as a bi-directional power converter;
charging the batteries from an AC power source under first conditions; and
providing charging power from the batteries to the DC charging station under second conditions.

21. The method of claim 20, wherein the first conditions exist when there are no or relatively small charging demands on the DC charging station, and wherein the second conditions exist when there are relatively high charging demands on the DC charging station.

22. The method of claim 20, further comprising:
periodically checking, by the power converter, the state-of-health of each module within each of the batteries to adjust a current supplied to each module within each of the batteries when charging, and
periodically checking, by the power converter, the state-of-health of each module within each of the batteries to adjust a current supplied by each module within each of the batteries when discharging.

23. The method of claim 20, further comprising regulating a bus voltage to a predetermined value associated with an operating voltage at the intermediate DC terminals when the first conditions comprise a loss of the input AC source of power.

24. The method of claim 18, further comprising individually controlling, by the multi-mode controller, each of the connected external loads and external sources.

25. (canceled)

26. (canceled)

27. The method of claim 24, further comprising controlling charging or discharging of an external source based on the state-of-health of each of the one or more external sources and/or loads.

28. (canceled)

29. The method of claim 24, further comprising adjusting energy or power flow directions and magnitude values between multiple type of energy sources and loads and with the DC charging station based on multiple parameters including at least one of efficiency, health, temperature, pricing/cost, and demand.
